(19) United States
(12) Patent Application Publication
(10) Pub. No.: US 2019/0050238 A1
(43) Pub. Date: Feb. 14, 2019

(54) PRIORITIZING DIGITAL ASSISTANT RESPONSES

(71) Applicant: MOTOROLA SOLUTIONS, INC, CHICAGO, IL (US)

(72) Inventors: BING QIN LIM, JELUTONG (MY); GUO DONG GAN, KUALA LUMPUR (MY); MUN YEW THAM, BAYAN LEPAS (MY); KONG YONG FOO, BAYAN LEPAS (MY)

(21) Appl. No.: 15/671,175

(22) Filed: Aug. 8, 2017

(51) Int. Cl. G06F 9/44; G10L 25/48; G06Q 10/04; H04W 4/22; H04W 4/00; G06K 9/00

(52) U.S. Cl. CPC G06F 9/4446; G10L 25/48; G06Q 10/04; G06K 9/00624; H04W 4/005; H04W 4/008; H04W 4/22

(57) ABSTRACT

A method and apparatus for providing a response/suggestion to a user by a digital assistant is provided herein. During operation the digital assistant will have knowledge of the status of devices connected to form a personal-area network (PAN), processed sensor data, and/or a current incident type. The digital assistant will then prioritize any responses/suggestions to the user based on the status of associated PAN devices and/or the incident type.

### BACKGROUND OF THE INVENTION

Tablets, laptops, phones (e.g., cellular or satellite), mobile (vehicular) or portable (personal) two-way radios, and other communication devices are now in common use by users, such as first responders (including firemen, police officers, and paramedics, among others), and provide such users and others with instant access to increasingly valuable additional information and resources such as vehicle histories, arrest records, outstanding warrants, health information, real-time traffic or other situational status information, and any other information that may aid the user in making a more informed determination of an action to take or how to resolve a situation, among other possibilities.

Many such communication devices further comprise, or provide access to, electronic digital assistants (or sometimes referenced as “virtual partners”) that may provide the user thereof with valuable information in an automated (e.g., without further user input) and/or semi-automated (e.g., with some further user input) fashion. The valuable information provided to the user may be based on explicit requests for such information posed by the user via an input (e.g., such as a parsed natural language input or an electronic touch interface manipulation associated with an explicit request) in which the electronic digital assistant may reactively provide such requested valuable information, or may be based on some other set of one or more context or triggers in which the electronic digital assistant may proactively provide such valuable information to the user absent any explicit request from the user.

As some existing examples, electronic digital assistants such as Siri provided by Apple, Inc.® and Google Now provided by Google, Inc.®, are software applications running on underlying electronic hardware that are capable of understanding natural language, and may complete electronic tasks in response to user voice inputs, among other additional or alternative types of inputs. These electronic digital assistants may perform such tasks as taking and storing voice dictation for future reference and retrieval, reading a received text message or an e-mail message aloud, generating a text message or e-mail message reply, looking up requested phone numbers and initiating a phone call to a requested contact, generating calendar appointments and providing appointment reminders, instructing users how to proceed with an assigned task, warning users of nearby dangers such as traffic accidents or environmental hazards, and providing many other types of information in a reactive or proactive manner.

Current implementations of virtual partners have all virtual-partner responses queued in a chronological order that is based on an order that the queries that were made by the user (users). However, during certain conditions, some virtual-partner responses would benefit from being prioritized over other responses even though the other responses had their queries made first. For example, during patrolling, an officer might make a query to search for a car plate number for a traffic violation. The officer may then see a robbery in progress and immediately query virtual-partner information about the address of the robbery. Because, the license-plate query was made first, the virtual partner will answer the license-plate query prior to providing valuable information on the robbery in progress.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates an operational environment for the present invention.

FIG. 2 depicts an example communication system that incorporates a personal-area network and a digital assistant.

FIG. 3 is a more-detailed view of a personal-area network of FIG. 2.

FIG. 4 is a block diagram of a dispatch center.

FIG. 5 is a block diagram of a hub.

FIG. 6 is a flow chart for determining a digital-assistant communication priority.

FIG. 7 is a flow chart for determining a digital-assistant communication priority.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for providing a response/suggestion to a user by a digital assistant is provided herein. During operation the digital assistant will have knowledge of a status of devices connected to form a personal-area network (PAN) and/or have knowledge of a current incident type assigned to a user. The digital assistant will then prioritize any responses/suggestions to the user based on the status of associated PAN devices and/or the incident type.

Expanding on the above, a virtual partner will re-prioritize a queue for responses based on the fact that a public-safety event has occurred. As discussed, the public-safety event may comprise a current incident assigned to a user, or a status of at least one device connected to form a PAN.

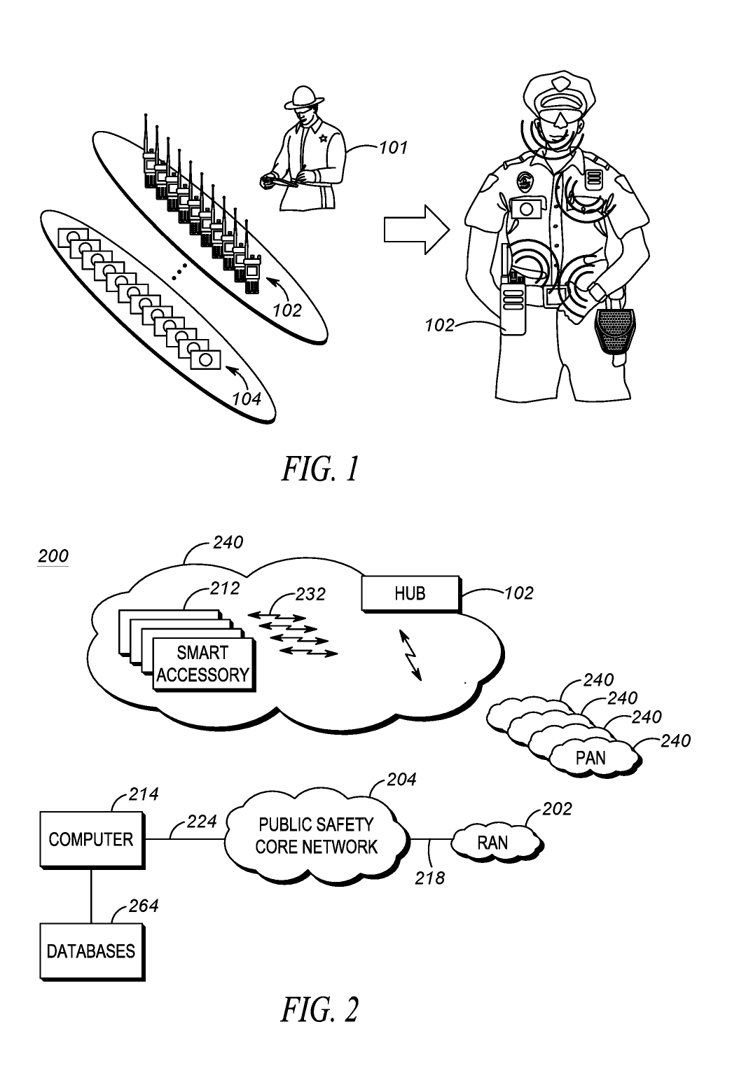

Turning now to the drawings, wherein like numerals designate like components, FIG. 1 illustrates an operational environment for the present invention. As shown, a public safety officer 101 will be equipped with devices that determine various physical and environmental conditions surrounding the public-safety officer. These conditions are generally reported back to a dispatch center so an appropriate action may be taken. For example, future police officers may have a sensor that determines when a gun is drawn. Upon detecting that an officer has drawn their gun, a notification may be sent back to the dispatch operator so that, for example, other officers in the area may be notified of the situation.

It is envisioned that the public-safety officer will have an array of shelved devices available to the officer at the beginning of a shift. The officer will select the devices off the shelf, and form a personal area network (PAN) with the devices that will accompany the officer on his shift. For example, the officer may pull a gun-draw sensor, a body-worn camera, a wireless microphone, a smart watch, a police radio, smart handcuffs, a man-down sensor, a bio-sensor, . . . , etc. All devices pulled by the officer will be configured to form a PAN by associating (pairing) with each other and communicating wirelessly among the devices. At least one device may be configured with a digital assistant. In a preferred embodiment, the PAN comprises more than two devices, so that many devices are connected via the PAN simultaneously.

A method called bonding is typically used for recognizing specific devices and thus enabling control over which devices are allowed to connect to each other when forming the PAN. Once bonded, devices then can establish a connection without user intervention. A bond is created through a process called “pairing”. The pairing process is typically triggered by a specific request by the user to create a bond from a user via a user interface on the device.

As shown in FIG. 1, public-safety officer 101 has an array of devices to use during the officer's shift. For example, the officer may pull one radio 102 and one camera 104 for use during their shift. Other devices may be pulled as well. As shown in FIG. 1, officer 101 will preferably wear the devices during a shift by attaching the devices to clothing. These devices will form a PAN throughout the officer's shift.

FIG. 2 depicts an example communication system 200 that incorporates PANs created as described above. System 200 includes one or more radio access networks (RANs) 202, a public-safety core network 204, hub (PAN master device) 102, local devices (slave devices that serve as smart accessories/sensors) 212, computer 214, and communication links 218, 224, and 232. In a preferred embodiment of the present invention, hub 102 and devices 212 form PAN 240, with communication links 232 between devices 212 and hub 102 taking place utilizing a short-range communication system protocol such as a Bluetooth communication system protocol. Each officer will have an associated PAN 240. Thus, FIG. 2 illustrates multiple PANs 240 associated with multiple officers.

RAN 202 includes typical RAN elements such as base stations, base station controllers (BSCs), routers, switches, and the like, arranged, connected, and programmed to provide wireless service to user equipment (e.g., hub 102, and the like) in a manner known to those of skill in the relevant art. RAN 202 may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, RAN 202 may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application may be implemented. In still further embodiments, RAN 202 may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

Public-safety core network 204 may include one or more packet-switched networks and/or one or more circuit-switched networks, and in general provides one or more public-safety agencies with any necessary computing and communication needs, transmitting any necessary public-safety-related data and communications.

For narrowband LMR wireless systems, core network 204 operates in either a conventional or trunked configuration. In either configuration, a plurality of communication devices is partitioned into separate groups (talkgroups) of communication devices. In a conventional narrowband system, each communication device in a group is selected to a particular radio channel (frequency or frequency & time slot) for communications associated with that communication device's group. Thus, each group is served by one channel, and multiple groups may share the same single frequency (in which case, in some embodiments, group IDs may be present in the group data to distinguish between groups using the same shared frequency).

In contrast, a trunked radio system and its communication devices use a pool of traffic channels for virtually an unlimited number of groups of communication devices (e.g., talkgroups). Thus, all groups are served by all channels. The trunked radio system works to take advantage of the probability that not all groups need a traffic channel for communication at the same time.

Group calls may be made between wireless and/or wireline participants in accordance with either a narrowband or a broadband protocol or standard. Group members for group calls may be statically or dynamically defined. That is, in a first example, a user or administrator may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and then provided some form of group identity or identifier, for example. Then, at a future time, an originating user in a group may cause some signaling to be transmitted indicating that he or she wishes to establish a communication session (e.g., join a group call having a particular talkgroup ID) with each of the pre-designated participants in the defined group. In another example, communication devices may dynamically affiliate with a group (and also disassociate with the group) perhaps based on user input, and the switching and/or radio network may track group membership and route new group calls according to the current group membership.

Hub 102 serves as a PAN master device, and may be any suitable computing and communication device configured to engage in wireless communication with the RAN 202 over the air interface as is known to those in the relevant art. Moreover, one or more hub 102 are further configured to engage in wired and/or wireless communication with one or more local device 212 via the communication link 232. Hub 102 will be configured to determine when to forward information received from PAN devices to, for example, a dispatch center. The information can be forwarded to the dispatch center via RANs 202 based on a combination of device 212 inputs. In one embodiment, all information received from sensors 212 will be forwarded to computer 214 via RAN 202. In another embodiment, hub 102 will filter the information sent, and only send high-priority information back to computer 214.

It should also be noted that any one or more of the communication links 218, 224, could include one or more wireless-communication links and/or one or more wired-communication links.

Devices 212 and hub 102 may comprise any device capable of forming a PAN. For example, devices 212 may comprise a gun-draw sensor, a body temperature sensor, an accelerometer, a heart-rate sensor, a breathing-rate sensor, a camera, a GPS receiver capable of determining a location of the user device, smart handcuffs, a clock, calendar, environmental sensors (e.g. a thermometer capable of determining an ambient temperature, humidity, presence of dispersed chemicals, radiation detector, etc.), an accelerometer, a biometric sensor (e.g., wristband), a barometer, speech recognition circuitry, a gunshot detector, . . . , etc. Some examples follow:

A sensor-enabled holster 212 may be provided that maintains and/or provides state information regarding a weapon or other item normally disposed within the user's sensor-enabled holster 212. The sensor-enabled holster 212 may detect a change in state (presence to absence) and/or an action (removal) relative to the weapon normally disposed within the sensor-enabled holster 212. The detected change in state and/or action may be reported to the portable radio 102 via its short-range transceiver. In some embodiments, the sensor-enabled holster may also detect whether the first responder's hand is resting on the weapon even if it has not yet been removed from the holster and provide such information to portable radio 102. Other possibilities exist as well.

A biometric sensor 212 (e.g., a biometric wristband) may be provided for tracking an activity of the user or a health status of the user 101, and may include one or more movement sensors (such as an accelerometer, magnetometer, and/or gyroscope) that may periodically or intermittently provide to the portable radio 102 indications of orientation, direction, steps, acceleration, and/or speed, and indications of health such as one or more of a captured heart rate, a captured breathing rate, and a captured body temperature of the user 101, perhaps accompanying other information.

An accelerometer 212 may be provided to measures acceleration. Single and multi-axis models are available to detect magnitude and direction of the acceleration as a vector quantity, and may be used to sense orientation, acceleration, vibration shock, and falling. The accelerometer 212 may determine if an officer is running. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing.

A heart rate sensor 212 may be provided and use electrical contacts with the skin to monitor an electrocardiography (EKG) signal of its wearer, or may use infrared light and imaging device to optically detect a pulse rate of its wearer, among other possibilities.

A breathing rate sensor 212 may be provided to monitor breathing rate. The breathing rate sensor may include use of a differential capacitive circuits or capacitive transducers to measure chest displacement and thus breathing rates. In other embodiments, a breathing sensor may monitor a periodicity of mouth and/or nose-exhaled air (e.g., using a humidity sensor, temperature sensor, capnometer or spirometer) to detect a respiration rate. Other possibilities exist as well.

A body temperature sensor 212 may be provided, and includes an electronic digital or analog sensor that measures a skin temperature using, for example, a negative temperature coefficient (NTC) thermistor or a resistive temperature detector (RTD), may include an infrared thermal scanner module, and/or may include an ingestible temperature sensor that transmits an internally measured body temperature via a short range wireless connection, among other possibilities. Temperature sensor 212 may be used on equipment to determine if the equipment is being worn or not. For example, temperature sensor 212 may exist interior to a bullet-proof vest. I the temperature sensor 212 senses a temperature above a predetermined threshold (e.g., 80 degrees), it may be assumed that the vest is being worn by an officer.

Computer 214 comprises, or is part of, a computer-aided-dispatch center (sometimes referred to as an emergency-call center), that may be manned by an operator providing necessary dispatch operations. For example, computer 214 typically comprises a graphical user interface that provides the dispatch operator necessary information about public-safety officers. As discussed above, much of this information originates from devices 212 providing information to hub 102, which forwards the information to RAN 202 and ultimately to computer 214.

Computer 214 comprises a virtual partner (e.g., a microprocessor serving as a virtual partner/digital assistant) that is configured to receive sensor data from sensors 212, keep track of relevant information and understand the situational context of user. The virtual partner will reactively provide officer-requested information, or may provide information automatically based one or more sensor status or triggers in which the virtual partner may proactively provide such valuable information to the user absent any explicit request from the user (e.g., “I see you have drawn your weapon, do you need assistance”).

Expanding on the above, each user of the system may possess a hub with many associated devices forming a PAN. For each user of the system, computer 214 may track the user's current associated PAN devices (sensors 212) along with sensor data for that user. This information may be used to compile a summary for each user (e.g., equipment on hand for each user, along with state information for the equipment). The information is preferably stored in database 264. This information may be used by any virtual partner to provide valuable content to the user. As discussed, the content may be provided spontaneously, or in response to a query.

With the above in mind, computer 214 is also configured with a natural language processing (NLP) engine configured to determine the intent and/or content of the any over-the-air voice transmissions received by users. The NLP engine may also analyze oral queries and/or statements received by any user and provide responses to the oral queries and/or take other actions in response to the oral statements. It should be noted that any over-the-air communication between users (e.g., on the talkgroup) will be monitored by the NLP engine in order to determine the content of the over-the-air voice transmission.

A computer-aided dispatch (CAD) incident identifier can be utilized by computer 214 to determine a current prioritization of any digital assistant content (queue) provided to a user. An incident identification (sometimes referred to as an incident scene identifier, or a CAD incident identifier (CAD ID)) is generated for incidents where an officer is dispatched/assigned, or where an officer encounters a public-safety event. This ID could be something as simple as a number associated with a particular incident type, or something as complicated as an identification that is a function of populated fields (e.g., time, location, incident type, . . . , etc.), one of which may comprise an incident type.

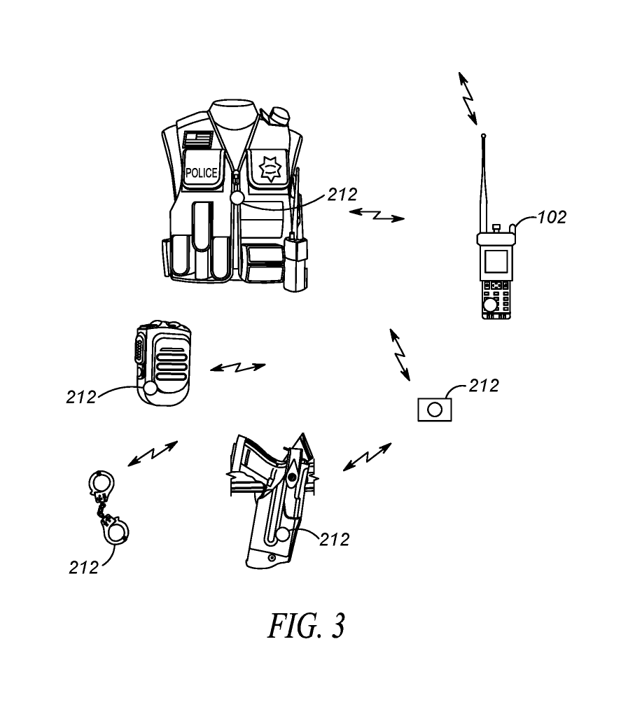

FIG. 3 depicts another view of a personal-area network 240 of FIG. 2. Personal-area network comprises a very local-area network that has a range of, for example 10 feet. As shown in FIG. 3, various devices 212 are that attach to clothing utilized by a public-safety officer. In this particular example, a bio-sensor is located within a police vest, a voice detector is located within a police microphone, smart handcuffs 212 are usually located within a handcuff pouch (not shown), a gun-draw sensor is located within a holster, and a camera 212 is provided.

Devices 212 and hub 102 form a PAN 240. PAN 240 preferably comprises a Bluetooth PAN. Devices 212 and hub 102 are considered Bluetooth devices in that they operate using a Bluetooth, a short range wireless communications technology at the 2.4 GHz band, commercially available from the “Bluetooth special interest group”. Devices 212 and hub 102 are connected via Bluetooth technology in an ad hoc fashion forming a PAN. Hub 102 serves as a master device while devices 212 serve as slave devices.

Hub 102 provides information to the officer, and/or forwards local status alert messages describing each sensor state/trigger event over a wide-area network (e.g., RAN/Core Network) to computer 214. In alternate embodiments of the present invention, hub 102 may forward the local status alerts/updates for each sensor to mobile and non-mobile peers (shift supervisor, peers in the field, etc), or to the public via social media. RAN core network preferably comprises a network that utilizes a public-safety over-the-air protocol. Thus, hub 102 receives sensor information via a first network (e.g., Bluetooth PAN network), and forwards the information to computer 214 via a second network (e.g., a public safety wide area network (WAN)). When the virtual partner is located within computer 214, any request to the virtual partner will be made via the second network. In addition, any communication from the virtual partner to computer 214 will take place using the second network.

As described above, since prior-art digital assistants do not prioritize responses to queries, the digital assistant may not provide a timely response/instructions to the user. In order to address this issue, all virtual partners (whether located within dispatch center 214 or hub 102) will prioritize responses based on public-safety events. These events may include the status of sensors 212, processed sensor data, and/or an incident type currently assigned to an officer.

As described above, a digital assistant may prioritize queries from users based on a status of sensors 212 that form a PAN with an officer. For example, if dispatch center 214, or hub 102 detects that Officer Smith has drawn his gun, answering Officer Smith's queries made to any digital assistant after the gun has been drawn will be prioritized over answering queries made to the digital assistant before the gun was drawn. In a similar manner, answering queries made by other officers (not having drawn their guns) will be de-prioritized over answers to queries made by Officer Smith. So, for example, assume Officer Smith queried a digital assistant for a license plate number, then for some reason had to draw his weapon. After the weapon has been drawn, Officer Smith then queries the digital assistant for a criminal history on the driver of a vehicle. The digital assistant will then attempt to answer Officer Smith's second question (criminal history) prior to answering the first question (license-plate information). In another example, the first query maybe no longer relevant to the second query, thus digital assistant could suspend on answering the first query until Officer Smith's weapon is keep back into the gun holster.

As described above, the virtual partner may also prioritize (e.g., attempt to answer first in time, prior to providing content to other users) statements and answers to questions made from officers assigned to a particular incident. So, for example, an officer assigned a first CAD ID by computer 214 will have a first prioritization, and an officer assigned a second CAD ID by computer 214, will have a second prioritization. The prioritization of the incident can be either manually set by the dispatch operator, or auto prioritized based on the sensor status of the officers assigned under the respective CAD ID. The sensor status further include processed sensor data that able to provide the context of the emergency level of the incident, particularly on the utterance speed and voice loudness of the officer during his query to a virtual partner that can be detected through a microphone sensor and processed through audio analytics (e.g., a natural-language processor). The processed data can also be used to determine if similar subject matter is detected on a current query and a previously-queued query (repeated subject matter queries from same person or different person under same CAD ID).

Expanding on the above, assume a dispatch operator receives an emergency call (e.g., 911 call) reporting a burglary in progress. The operator instructs computer to assign this incident to Officer Fred. Officer Fred is assigned a CAD ID corresponding to a burglary in progress. Because of this, Officer Fred's queries to the virtual partner will be prioritized over, for example, Officer Smith's queries (assuming officer Smith is currently not assigned to an incident of similar priority). In a similar manner, answers to Officer Fred's queries made after being assigned to the incident will be prioritized over answers to Officer Fred's queries made before being assigned to the incident.

In another example, Officer Ethan and his teammates are assigned to patrol in one area with CAD ID #ABC123, while Officer Darren and his teammates are assigned to patrol in another different area with CAD ID #DEF456. During patrolling, Officer Ethan found something threatening at an abandoned house and drew his gun. CAD ID #ABC123 will be auto assigned a higher priority on virtual partner response compared to CAD ID #DEF456, and any query made by Officer Ethan and his teammates (regardless if his teammates also draw their guns or not) will be prioritized. In one embodiment, the weight of the prioritization will be varied based on aggregated status of the sensors of the whole team members. For example, incident with five officers having their gun drawn will be prioritized over incident with only one officer draw his or her gun.

In another example, Officer Serena is patrolling with her partner. While querying regarding a motorcycle that is parked illegally, she saw someone running into a bank carrying something that looks like a gun. Due to the urgency, she query loud and fast to the virtual partner to retrieve the CCTV image on that person to confirm if that person is armed: She states loudly, “Hey virtual partner! Check out if the person with yellow cap entering OCBC bank is armed!!!” as compared to her previous slow and steady tone when querying regarding the illegally parked motorcycle. Officer Serena's audio data during her query is collected through microphone sensor and processed to determine that the loudness (audio data amplitude) and utterance speed (time duration on the parsed wording separation) is exceeding certain threshold and thus the virtual partner communication and response for CCTV image retrieval is prioritized over the previous query regarding the illegal parking of the motorcycle.

In another example, Officer Serena & her partner Officer Lim are patrolling. While querying on nearest route to the next destination and retrieving recent past incidents on the next patrolling destination. Officer Serena saw a person entering a Bank and recognize that the person is a wanted person that perform robbery last month but she cannot be sure. She immediately queries for face recognition through CCTV near the bank on the particular person: “Virtual partner, verify that the person entering the OCBC bank is Jacky Smith! The wanted robber!” While the virtual partner is still processing the prior queries regarding the patrolling navigation and past incident, the more urgent query on face recognition on the robbery suspect is queued after the prior queries and pending for processing. Due to the urgency, Officer Serena repeated the query to virtual partner: In another scenario, her partner Lim saw the same scenario almost at the same time and query to virtual partner: “Eh that's Jacky! Virtual partner, did Jacky Smith just enter the OCBC bank?”.

In the first scenario, the virtual partner will determine that the subject matter of both Officer Serena's first and second queries are similar. In the second scenario, the virtual partner will determine that the subject matter of Offer Serena's query (from audio data detected by Serena's PAN device) is similar to the subject matter of Officer Lim's query (from audio data detected by Lim's PAN device). In both scenarios, upon detecting similar subject matter from two or more queries (either repeated by herself or her partner who under same CAD ID/talkgroup/WAN network), the repeated query will be prioritized over prior queries of patrolling navigation and past incident.

In another example, Officer Ethan is patrolling with his tablet and RSM (remote speaker microphone) worn on his body. When he sees a suspicious person and queries about the person. At a later time, Officer Ethan spies another suspicious person running. Officer Ethan pursues the person and his motion sensor detects running, generates a CAD ID associated with a pursuit, and assigns a priority level to any further query based on the incident type. While running, Officer Ethan again queries to the virtual partner and the virtual partner now prioritizes any response over past responses.

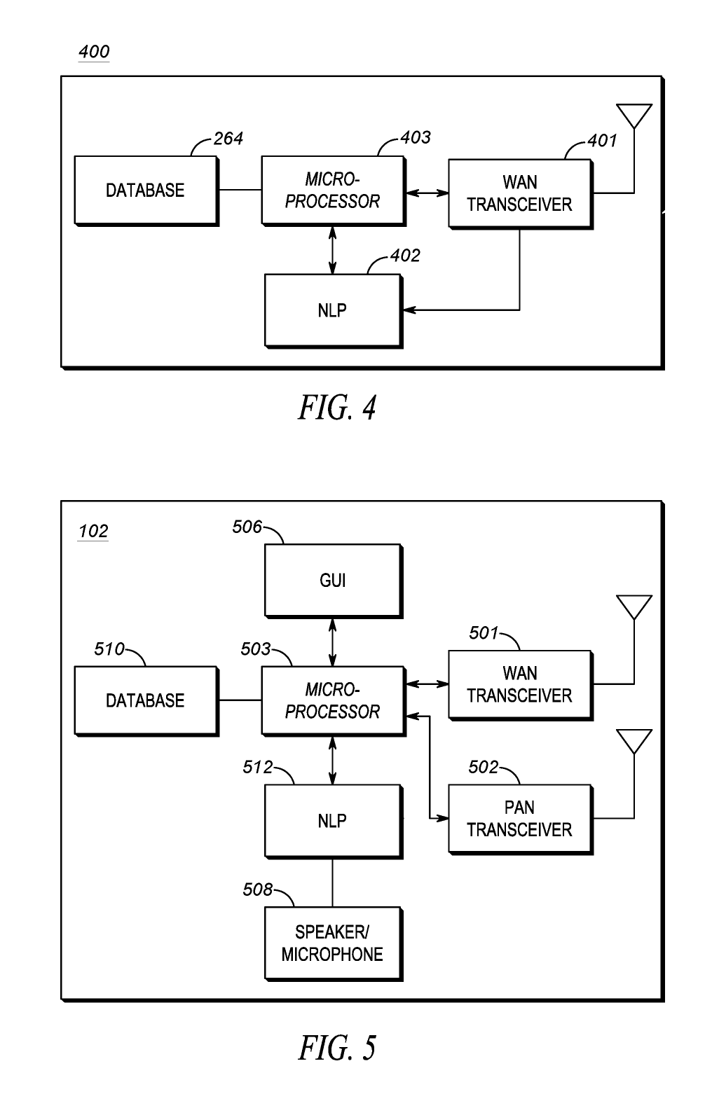

With the above examples in mind, FIG. 4 sets forth a schematic diagram that illustrates a device 400 for a digital assistant to determine a public-safety event (e.g., a status of devices/equipment and/or an incident assigned to an officer), and prioritize a response accordingly. In an embodiment, the device is embodied within computer 214 (dispatch center 214), however in alternate embodiments the device may be embodied within the public-safety core network 204, or more computing devices in a cloud compute cluster (not shown), or some other communication device not illustrated in FIG. 2, and/or may be a distributed communication device across two or more entities. In this particular embodiment, device 400 may receive multiple queries from multiple officers, and prioritize them as described above, or alternatively, may receive multiple requests from the same officer, and prioritize them as described above.

FIG. 4 shows those components (not all necessary) for device 400 to determine what equipment is present, determine a status of the equipment present, determine an incident assigned to an officer, and to prioritize any response accordingly. For ease of illustration some components have been left out of FIG. 4. For example, a graphical user interface that provides the dispatch operator necessary information about public-safety officers is not shown since that component is not necessary for understanding the following discussion.

As shown, device 400 may include a wide-area-network (WAN) transceiver 401 (e.g., a transceiver that utilizes a public-safety communication-system protocol), Natural Language Processor (NLP) 402, logic circuitry 403 (which may serve as a digital assistant). In other implementations, device 400 may include more, fewer, or different components. Regardless, all components are connected via common data busses as known in the art.

WAN transceiver 401 may comprise well known long-range transceivers that utilize any number of network system protocols. (As one of ordinary skill in the art will recognize, a transceiver comprises both a transmitter and a receiver for transmitting and receiving data). For example, WAN transceiver 401 may be configured to utilize a next-generation cellular communications protocol operated by a cellular service provider, or any public-safety protocol such as an APCO 25 network or the FirstNet broadband network. WAN transceiver 401 receives communications from users, as well as sensor data from users. It should be noted that WAN transceiver 401 is shown as part of device 400, however, WAN transceiver 401 may be located in RAN 202 (e.g., a base station of RAN 202), with a direct link to device 400.

NLP 402 may be a well known circuitry to analyze, understand, and derive meaning from human language in a smart and useful way. By utilizing NLP, automatic summarization, translation, named entity recognition, relationship extraction, sentiment analysis, speech recognition, and topic segmentation can take place.

Logic circuitry 403 comprises a digital signal processor (DSP), general purpose microprocessor, a programmable logic device, or application specific integrated circuit (ASIC) and is configured (along with NLP 402) to serve as a digital assistant/virtual partner a users of the system. For example, logic circuitry may provide the user thereof with valuable information in an automated (e.g., without further user input) or semi-automated (e.g., with some further user input) fashion. The valuable information provided to the user may be based on explicit requests for such information posed by the user via an input (e.g., such as a parsed natural language input or an electronic touch interface manipulation associated with an explicit request) in which the electronic digital assistant may reactively provide such requested valuable information, or may be based on some other set of one or more context or triggers (i.e., the joining of a talkgroup, a sensor status, . . . , etc.) in which the electronic digital assistant may proactively provide such valuable information to the user absent any explicit request from the user.

With the above in mind, and as an example, device 4000 (logic circuitry) may be continuously compiling a history of user's associated PAN sensors and their status, along with any incident assigned to users. This information may be stored in database 264. Hub 102 may send a query to device 400 (e.g., to computer 214 when device 400 is embodied within computer 214). Such a query may be something as simple as “advice please”, or may be more specific, such as, “Please give me advice on how to handle this heart-attack victim”. Alternatively, no query may be sent, and device 400 may simply provide information unsolicited (e.g., based on received sensor information). Device 400 may send a response to hub 102. As discussed above, the response may be prioritized over other responses (received from hub 102, or other hubs) based on the state of such PAN devices or an incident type assigned.

Database 264 is provided. Database 264 comprises standard memory (such as RAM, ROM, . . . , etc) and serves to store user identifications along with associated hubs 102, their PAN device statuses (device states), and any incident assigned to the hub (user of the hub). As an example, PAN state information may comprise a battery level, ammunition level, RF signal strength, inventory of emergency aid such as adrenaline shots, gauze, a loudness of any query, whether or not a gun has been drawn, . . . , etc. Incidents assigned to a hub may take the form of any public-safety incident, such as, but not limited to, robberies, burglaries, murders, homicides, assaults, traffic stops, . . . , etc.

It should be noted that the above description had the digital assistant functionality encompassed within dispatch center 214. In an alternate embodiment this functionality may be encompassed within hub 102. When encompassed within hub 102, the digital assistant will prioritize information provided to a single user based on whether or not a public-safety event has occurred. This is shown in FIG. 5. As shown, hub 102 includes a wide-area-network (WAN) transceiver 501 (e.g., a transceiver that utilizes a public-safety communication-system protocol), PAN transceiver 502 (e.g., a short-range transceiver), Graphical User Interface (GUI) 506, database 510, logic circuitry 503, speaker 508 and NLP 512. In other implementations, hub 102 may include more, fewer, or different components. For example, if digital-assistant functionality is being provided by dispatch center 214, then database 510 and NLP 512 may be absent from hub 102.

WAN transceiver 501 may comprise well known long-range transceivers that utilize any number of network system protocols. (As one of ordinary skill in the art will recognize, a transceiver comprises both a transmitter and a receiver for transmitting and receiving data). For example, WAN transceiver 501 may be configured to utilize a next-generation cellular communications protocol operated by a cellular service provider, or any public-safety protocol such as an APCO 25 network or the FirstNet broadband network. WAN transceiver 501 provides sensor status updates to dispatch center 214.

PAN transceiver 502 may be well known short-range (e.g., 30 feet of range) transceivers that utilize any number of network system protocols. For example, PAN transceiver 502 may be configured to utilize Bluetooth communication system protocol for a body-area network, or a private 802.11 network. PAN transceiver forms the PAN (acting as a master device) with various sensors 212.

GUI 506 comprises provides a way of displaying information and receiving an input from a user. For example, GUI 506 may provide a way of conveying (e.g., displaying) information to a user regarding that status of devices 212.

Speaker/microphone 408 provides a mechanism for receiving human voice and providing it to the virtual partner (e.g., logic circuitry 503/NLP 512), along with providing audible information generated by the digital assistant (e.g., a voice). Speaker/microphone 408 may receive queries from a user and provide the queries to logic circuitry 403, acting as a digital assistant.

Logic circuitry 403 comprises a digital signal processor (DSP), general purpose microprocessor, a programmable logic device, or application specific integrated circuit (ASIC) and is configured along with NLP 512 to provide digital assistant functionality.

Database 110 is provided. Database 410 comprises standard memory (such as RAM, ROM, . . . , etc) and serves to store PAN member names (identifications), their statuses, and any incident assigned to hub 102. So, for example, database 410 may comprise a list of PAN members (long gun, bullet-proof vest, gun-draw sensor, accelerometer, . . . , etc.) that formed a PAN with hub 102. Database 410 also store status information for each sensor (e.g., long gun in use, bullet-proof vest being worn, dun-draw sensor indicating a gun is holstered, . . . , etc.).

NLP 12 may be a well known circuitry to analyze, understand, and derive meaning from human language in a smart and useful way. By utilizing NLP, automatic summarization, translation, named entity recognition, relationship extraction, sentiment analysis, speech recognition, and topic segmentation can take place.

The digital assistant (i.e., hub 102) will prioritize responses to any query, or will prioritize alerts provided by the digital assistant based on a status of PAN devices connected to hub 102 and/or based on an incident assigned to an officer utilizing hub 102.

Regardless of whether or not virtual-partner functionality exists within hub 102 or dispatch center 214, the virtual partner will map a priority of a communication (e.g., an answer to a query, or a spontaneous response based on sensor status) to sensor status and/or incident type. The mapping process preferably comprises an operation that associates each element of a given set (the domain) with one or more elements of a second set (the range). The public-safety event (e.g., PAN sensor statuses and/or the CAD ID) for a user comprises the domain, while the response priority comprise the range.

The mapping may be explicit based on predefined rules, or the mapping may be trained via neural network modeling. The priority level (i.e., the range) may comprise a numerical value, for example, a number between 0 and 9. The mapping is done by determining PAN member status and/or CAD ID for a user, and mapping this information to a priority level. For example, assume Officer Smith is assigned to a burglary, and has a weapon drawn. This combination (domain) may be mapped to a level 9 priority. Similarly, Officer Fred may currently not be assigned to an incident, and have no weapon drawn. Officer Fred may be mapped to a level 0 priority (the lowest).

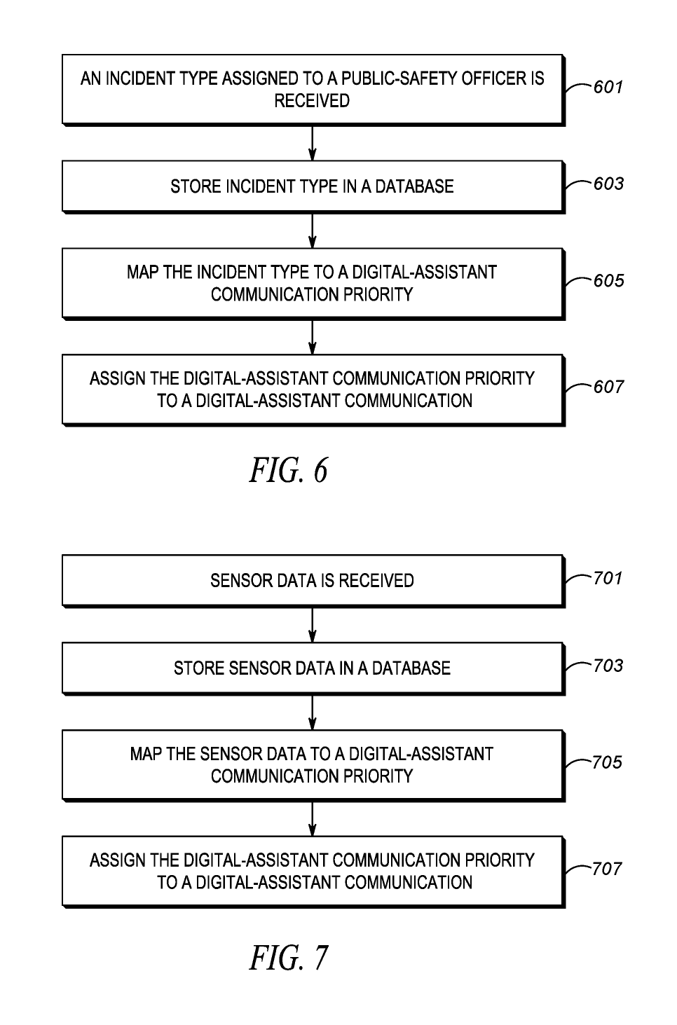

FIG. 6 is a flow chart for determining a digital-assistant communication priority. The logic flow begins at step 601 where an incident type assigned to a public-safety officer is received by logic circuitry and stored in a database (step 603). Logic circuitry maps the incident type to a digital-assistant communication priority (step 605) and assigns the digital-assistant communication priority to a digital-assistant communication (step 607).

As discussed above, the digital-assistant communication may be outputting to a GUI or a speaker if the digital assistant is embodied within a hub, or may be output via a WAN to a hub if the digital assistant is embodied within a dispatch center.

Additionally, sensor data may be received from a plurality of sensors that form a PAN and the step of mapping may comprise the step of mapping both the incident type and the sensor data to the digital-assistant communication priority.

Additionally, a query may be received, and the digital-assistant communication may be in response to the received query.

As discussed, digital-assistant communications with a higher digital-assistant communication priority will take place prior to digital-assistant communications with a lower digital-assistant communication priority.

FIG. 7 is a flow chart for determining a digital-assistant communication priority. The logic flow begins at step 701 where sensor data is received from a plurality of sensors that form a PAN and stored (step 703). At step 705 the sensor data is mapped to a digital-assistant communication priority and assigned a digital-assistant communication (step 707).

As discussed above, the digital-assistant communication may be outputting to a GUI or a speaker if the digital assistant is embodied within a hub, or may be output via a WAN to a hub if the digital assistant is embodied within a dispatch center.

Additionally, an incident type may be received and the step of mapping may comprise the step of mapping both the incident type and the sensor data to the digital-assistant communication priority.

Additionally, a query may be received, and the digital-assistant communication may be in response to the received query.

As discussed, digital-assistant communications with a higher digital-assistant communication priority will take place prior to digital-assistant communications with a lower digital-assistant communication priority.

The above description provides for an apparatus comprising a wide-area network transceiver receiving an incident type assigned to a public-safety officer, a database storing the incident type, and logic circuitry mapping the incident type to a digital-assistant communication priority and assigning the digital-assistant communication priority to a digital-assistant communication. A speaker is provided for outputting the digital-assistant communication.

A personal-area-network (PAN) transceiver may be provided for receiving sensor data from a plurality of sensors that form a PAN, and wherein the logic circuitry maps both the incident type and the sensor data to the digital-assistant communication priority.

The apparatus may further comprise a microphone receiving a query, and wherein the digital-assistant communication is in response to the received query.

The sensor data comprises data that a gun has been drawn, an audio level of a query, and/or a subject-matter of a query.

The above description provides for an apparatus comprising a personal-area network (PAN) transceiver forming a PAN with a plurality of sensors, a database comprising sensor data from the sensors that form the PAN, and logic circuitry mapping the stored sensor data to a digital-assistant communication priority and formulating a digital-assistant communication having the digital-assistant communication priority.

A graphical user interface (GUI) or speaker may be provided for outputting the digital-assistant communication. Additionally, a wide-area network (WAN) transceiver may be provided for transmitting the sensor data to a dispatch center as well as receiving an incident identification from a dispatch center. The logic circuitry may also map the stored sensor data and the incident identification to the digital-assistant communication priority.

A natural-language processor may be provided for receiving a query, and wherein the digital-assistant communication is formulated based on the query.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a wide-area network transceiver configured to receive an incident type assigned to a public-safety officer;
a microphone configured to receive a query for a digital assistant from the public-safety officer;
natural-language processing (NLP) circuitry configured to receive the query from the public-safety officer and formulate a digital-assistant communication that comprises a response to the query;
a database configured to store the incident type;
logic circuitry configured to map the incident type to a digital-assistant communication priority and assign the digital-assistant communication priority to the digital-assistant communication that is the response to the query, the logic circuitry also configured to reprioritizing a queue of digital-assistant communications based on the priority; and
a speaker configured to output the digital-assistant communication based on the priority.

2. The apparatus of claim 1 further comprising:
a personal-area-network (PAN) transceiver receiving sensor data from a plurality of sensors that form a PAN; and
wherein the logic circuitry maps both the incident type and the sensor data to the digital-assistant communication priority.

3. The apparatus of claim 2 further comprising a microphone receiving a query, and wherein the digital-assistant communication is in response to the received query.

4. The apparatus of claim 3 wherein digital-assistant communications with a higher digital-assistant communication priority will take place prior to digital-assistant communications with a lower digital-assistant communication priority.

5. The apparatus of claim 4 wherein the sensor data comprises data that a gun has been drawn, an audio level of a query, and/or a subject-matter of a query.

6. An apparatus comprising:
a personal-area network (PAN) transceiver forming a PAN with a plurality of sensors;
a database comprising sensor data from the sensors that form the PAN;
natural-language processing (NLP) circuitry configured to receive a query from a public-safety officer and formulating a response to the query as a digital-assistant communication;
logic circuitry mapping the sensor data to a digital-assistant communication priority and reprioritizing a queue of digital-assistant communications based on the digital-assistant communication priority; and
a graphical user interface (GUI) or speaker outputting the response to the query based on the priority.

7. The apparatus of claim 6 further comprising:
a wide-area network (WAN) transceiver transmitting the sensor data to a dispatch center.

8. The apparatus of claim 6 further comprising:
a wide-area network (WAN) transceiver receiving an incident identification from a dispatch center; and
wherein the logic circuitry maps the sensor data and the incident identification to the digital-assistant communication priority.

9. The apparatus of claim 6 further comprising:
a natural-language processor receiving a query, and wherein the digital-assistant communication, is formulated based on the query.

10. The apparatus of claim 6 wherein digital-assistant communications with a higher digital-assistant communication priority will take place prior to digital-assistant communications with a lower digital-assistant communication priority.

11. The apparatus of claim 6 wherein the sensor data comprises data that a gun has been drawn, an audio level of a query, and/or a subject-matter of a query.

12. A method comprising the steps of:
receiving an incident type assigned to a public-safety officer;
storing the incident type;
receiving a query from the public-safety officer;
determining a digital-assistant communication that is a response to the query;
mapping the incident type to a digital-assistant communication priority and assigning the digital-assistant communication priority to the digital-assistant communication;
reprioritizing a queue of digital-assistant communications; and
outputting the digital-assistant communication based on the step of reprioritizing.

13. The method of claim 12 further comprising the steps of:
receiving sensor data from a plurality of sensors that form a PAN; and
wherein the step of mapping comprises the step of mapping both the incident type and the sensor data to the digital-assistant communication priority.

14. The method of claim 12 further comprising the step of receiving a query, and wherein the digital-assistant communication is in response to the received query.

15. The method of claim 14 wherein digital-assistant communications with a higher digital-assistant communication priority will take place prior to digital-assistant communications with a lower digital-assistant communication priority.

16. A method comprising the steps of:
receiving sensor data from a plurality of sensors that form a PAN;
receiving a query from a public-safety officer;
formulating a digital-assistant communication that is a response to the query;
storing the sensor data;
mapping the sensor data to a digital-assistant communication priority and assigning the digital-assistant communication priority to the digital-assistant communication;
outputting the digital-assistant communication based on the priority.

17. The method of claim 16 further comprising the steps of:
receiving an incident type assigned to a public-safety officer; and
wherein the step of mapping comprises the step of mapping both the incident type and the sensor data to the digital-assistant communication priority.

18. The method of claim 17 further comprising the step of receiving a query, and wherein the digital-assistant communication is in response to the received query.

19. The method of claim 16 wherein digital-assistant communications with a higher digital-assistant communication priority will take place prior to digital-assistant communications with a lower digital-assistant communication priority.

20. The method of claim 16 further comprising the step of receiving a query, and wherein the digital-assistant communication is in response to the received query.
